(19) United States
(12) Patent Application Publication
(10) Pub. No.: US 2021/0194230 A1
(43) Pub. Date: Jun. 24, 2021

(54) WIRE SPACING AND BRACING MANAGEMENT SYSTEM

(71) Applicant: BRETT GUYATT, LAKE HAVASU CITY, AZ (US)

(72) Inventor: BRETT GUYATT, LAKE HAVASU CITY, AZ (US)

(21) Appl. No.: 17/127,646

(22) Filed: Dec. 18, 2020

Related U.S. Application Data
(60) Provisional application No. 62/950,145, filed on Dec. 19, 2019.

(51) Int. Cl. H02G 3/00; H02G 1/06; H02G 3/08

(52) U.S. Cl. CPC H02G 3/263; H02G 3/081; H02G 1/06

(57) ABSTRACT

Described herein is a wire spacing and bracing management device and system. The cable bracket device is designed to span between two studs or upright braces and be attached thereto. The cable bracket is equipped with preset zip tie holes or slots along its length and has nail or screw holes for stud attachment. The cable bracket includes thumb sliders along its length for ease of movement of a set of L-shaped brackets disposed on each end of the cable bracket. The cable bracket device provides a device that is adjustable, easily mountable, and configurable depending on the cable locations and construction structure. An intermediate bar member spanning the two studs may be planar, may be or be supported by a sheet metal spine, or may be or support a connector platform. Wires, cables, and gang boxes may be mounted thereon.

### CLAIM OF PRIORITY

This application claims priority to and the benefit of U.S. Provisional application with Ser. No. 62/950,145, filed on Dec. 19, 2019, which is incorporated herein by reference in its entirety.

### FIELD OF THE INVENTION

The inventive concept relates generally to a wire spacing and bracing management system for construction and electrical installations.

### BACKGROUND

Currently, there are a number of solutions for spacing wires between studs. One of these solutions attempts to hold one wire at a time, but this solution fails to meet the needs of the market because holding one wire at a time is time consuming. Another solution attempts to use an assistant, but this solution is similarly unable to meet the needs of the market because there may not be another person available. Still another solution seeks to utilize a stapler for securing wires, but this solution also fails to meet market needs because staplers and staples may not properly organize the wires or cables and in some cases can damage the wiring. Therefore, there currently exists a need in the market for an apparatus or system that braces and evenly spaces electrical wires and cables between studs and that complies with the NEC (National Electric Code).

### SUMMARY OF THE INVENTION

There is provided a wire spacing and bracing management system and method for use in residential and commercial construction that reduces installation time while meeting code regulations for electrical installations. The inventive concept allows a user to space and affix wires a predetermined distance out of electrical panels and outlet boxes according to NEC regulations or other such regulations as may be in place. The inventive concept saves time, labor, and provides instant, sufficient spacing for wiring using a simple zip tie or other such securing cords or cables to an adjustable bracket. In the preferred embodiment, fastening is within 12″ of entering the electrical panel and stud bay, but a variety of ranges are configurable using the inventive concept and easily repeatable during an overall wiring process because the inventive concept is adjustable and can be preset before installation. Hole or slot members may be general or may have features specific to an attachment member such as a screw, for example, an inner sidewall tapered at an acute angle to be flush to a screw with a tapered head.

The preferred embodiment uses zip ties or cable ties to secure wires or cables to the inventive concept wherein the zip ties circumscribe one or more wires or cables and a solid width or length of the inventive concept between two hole members or one hole member and a side member of the inventive concept. The zip ties typically eliminate the need for traditional staples.

The inventive concept can be secured to side wall supports such as a wooden beam, for example, the common two-by-four (2 inches depth by 4 inches width) known by people of ordinary skill in the art for general construction and can also be secured on top of trusses or between joists for managing/organizing wire flow through ceilings and floors, wood being a common but not exclusive attachment surface. Polymer, masonry, concrete, and metallic attachment surfaces may also be used, as well as dry wall, and adhesives could be used to secure the inventive concept though the preferred embodiment uses nails or screws.

The inventive concept, which a person of ordinary skill in the art may term a bracket, is adjusted in width and depth to fit between wall studs or floor joists. In some embodiments, the user can press thumb slides on the back or sides to extend or retract bracket arms.

It would be advantageous to have a wire spacing and bracing management system that is adjustable and easily configurable to accommodate the existing building structure. Furthermore, it would be advantageous to have a wire spacing and bracing management system that is easily mountable and durable should the wire spacing and bracing management system need to be moved.

The inventive concept advantageously fills the aforementioned deficiencies by providing a wire spacing and bracing device which provides a way for users to properly space and affix wires or cables a certain or requisite distance apart due to code regulations. In one example embodiment, the inventive concept is an adjustable wire spacer device that includes zip tie holes or slots and includes one or more thumb sliders for configuring the device. The inventive concept fulfills the need for electrical wire holding and spacing.

In one example embodiment, there is provided a cable or wire management bracket member including an intermediate bar member having a plurality of holes or slots located along a length of the bar member, the bar member having distal ends. The cable bracket also includes a first and second L-shaped support member located at each distal end, respectively, each L-shaped support member having a side support member protruding laterally from the intermediate bar member. The cable bracket device further includes a plurality of tie down members designed to protrude through a subset of the holes or slots so as to brace or secure a cable or wire to the intermediate bar member.

In a related example embodiment, the cable management bracket has L-shaped support members that include a sliding side support member designed to extend and contract laterally from the intermediate bar member to increase or decrease a length of the cable management bracket. In another related example, the L-shaped support members are designed to extend and contract laterally and perpendicularly from the intermediate bar member to increase or decrease a depth of the cable management bracket. In one or more example embodiments, the side support member of the cable bracket member includes a tab extending from the side support member designed for attaching the cable management bracket to a stud or other fixture and may further include one or more thumb sliders coupled to the L-shaped brackets and side supports to facilitate sliding movement along a length of the intermediate bar member and along the L-shaped brackets.

In one embodiment of the cable or wire management bracket system, the intermediate bar member has one or more holes or slots located along a length of the bar member, the bar member having distal ends. The longitudinal slide support members are contiguous to and are slidably coupled to longitudinal side portions of the intermediate bar member to facilitate sliding movement along the length of the intermediate bar member. A first and second L-shaped support member is located at each distal end, respectively, each L-shaped support member having a side support member protruding substantially laterally from the intermediate bar member. The lateral slide support members are contiguous to and slidably coupled to latitudinal side portions of the L-shaped support member to facilitate sliding movement along a length of the L-shaped support member disposed substantially perpendicular to the intermediate bar member length. One or more tie down members (or cable ties) is designed to brace or secure a cable or wire substantially to the intermediate bar member. The tie down members may be disposed through the slot or hole members or may be coupled to another element coupled to the intermediate bar member or the bar member itself without the use of a slot or hole.

A related embodiment further includes one or more thumb sliders coupled to the L-shaped brackets and side supports to facilitate sliding movement along a length of the intermediate bar member and along the L-shaped brackets. In another related embodiment, a sheet metal spine member is incorporated as the intermediate bar member extending along the length of an intermediate bar member position substantially equidistant from a center portion of the length of the intermediate bar member position. The metal spine member is designed to allow the intermediate bar member position to support more weight than the intermediate bar member alone that is not also the metal spine member. In some embodiments, the metal spine member may serve as the intermediate bar member. In one further embodiment, a substantially symmetrical, substantially cuboid, planarly disposed, detachable, connector platform is removably coupled lengthwise to the length of the intermediate bar member or assemblies thereon, a plurality of substantially rectangular slot assembly members disposed along the length of the connector platform, each slot assembly member including at least one circumscribable side portion, the connector platform designed to be mounted by at least one gang box member (or multi-gang box member) or one or more cable or wire members, the cable or wire members circumscribed by at least one tie down member, the tie down member circumscribing at least one of the at least one circumscribable side portions. In one further embodiment, at least one L-shaped attachment stud is disposed adjacent to and coplanar to at least one rectangular slot assembly member of the connector platform, the foot portion of the L-shaped attachment substantially perpendicular to the stem portion and designed to extend to substantially overlay the thickness of the tie down member circumscribing the stem portion.

In one embodiment, a cable or wire management bracket method involves attaching to a surface the intermediate bar member having one or more hole or slot members located along a length of the bar member, the bar member having distal ends. Longitudinally sliding slide support members are contiguous to and slidably coupled to longitudinal side portions of the intermediate bar members facilitating sliding movement along a length of the intermediate bar member to set the length of the intermediate bar member. Attaching to a surface a first and second L-shaped support member located at each distal end, respectively, each L-shaped support member having a side support member protruding substantially laterally from the intermediate bar member. Laterally sliding lateral support members contiguous to and slidably coupled to latitudinal side portions of the L-shaped support member facilitating sliding movement along a length of the L-shaped support member disposed substantially perpendicular to the intermediate bar member length to set the length of the L-shaped support members and corresponding depth of the cable and wire management bracket. Using one or more tie down members to brace or secure a cable or wire substantially to the intermediate bar member.

A related embodiment further includes one or more thumb sliders coupled to the L-shaped brackets and side supports to facilitate sliding movement along a length of the intermediate bar member and along the L-shaped brackets. In a related embodiment, a sheet metal spine member is incorporated as the intermediate bar member extending along the length of the intermediate bar member substantially equidistant from a center portion of the length of the intermediate bar member position. In a related embodiment, a substantially symmetrical, substantially cuboid, planarly disposed, detachable, connector platform is removably coupled along a length of the intermediate bar member or assemblies thereon, a plurality of substantially rectangular slot assembly members disposed along the length of the connector platform, each slot assembly member including at least one circumscribable side portion, the connector platform mounted by one or more of a wire, cable, or gang box member, the wire or cable members circumscribed by at least one tie down member. In a related embodiment, at least one L-shaped attachment stud is disposed adjacent to and coplanar to at least one rectangular slot assembly member of the connector platform, the foot portion of the L-shaped attachment substantially perpendicular to the stem portion, a tie down member coupling each of at least one wire or cable member contiguously abutting the stem portion of the at least one L-shaped attachment member, the foot portion of the at least one L-shaped attachment member substantially overlaying the thickness of the tie down member circumscribing the stem portion.

The connector platform is designed to be mounted by at least one gang box member or one or more cable or wire members, the cable or wire members circumscribed by at least one tie down member, the tie down member circumscribing at least one of the at least one side portions. One of ordinary skill in the art would recognize that the connector platform may be coupled to the intermediate bar member, or assemblies thereon, by clip members disposed on the connector platform or by attachment members such as a screw or nail member with at least one slot or hole member disposed through the connector platform, therefore. The connector platform may be coupled directly to a surface without being coupled to the intermediate bar member or assemblies thereon. The connector platform may, substantially, serve the attachment role of the intermediate bar member.

In one embodiment of the connector platform, at least one L-shaped attachment stud is disposed adjacent to and coplanar to at least one rectangular slot assembly member, the foot portion of the L-shaped attachment substantially perpendicular to the stem portion and designed to extend to substantially overlay the thickness of the tie down member circumscribing the stem portion. The connector platform, in this embodiment, is designed to handle wire or cable members running substantially perpendicular to each other. In one One embodiment of the connector platform features a semi-circular divot that can be circumscribed by polymer cables such as zip ties.

The inventive concept, in some embodiments, can adjust in width and depth, adjustable to the required height based on custom layouts, state laws and regulations, and is well-suited to industry standard metal encased (Romex) wires.

One embodiment of the inventive concept allows the main spine, bar, and arms to adjust in both depth and width. This allows a user to use the same example of the inventive concept for various types of electrical layouts and electrical boxes. The user adjusts placement. The sheet metal spine may be incorporated as or into the intermediate bar member to support heavier loads than suitable for the intermediate bar member without the support. The intermediate bar member is made from a metal but may also be made from a polymer. The sheet metal spine may have one or more hole or slot members to support attachment members. The connector platform, if coupled to the intermediate bar member of the inventive concept, provides a mounting platform for wires, cables, and gang boxes that is substantially fixed in width while the intermediate bar member can be extended or contracted, the lengths of the intermediate bar member and the L-shaped support members, then secured using one or more tab members, clip members, or attachment members such as screws. Adjustments may be made to optimize the inventive concept for commonly used construction measures, for example, for the inventive concept to be disposed on the four inch width of a two-by-four inch board commonly used in housing construction or the six inch width of another, common, wider board.

In the preferred embodiment, the plurality of substantially rectangular slot assemblies of the intermediate bar member would exhibit substantially the equivalent detail as stud mounting brackets commonly used by those of ordinary skill in the art.

Tab members may extend from embodiments of the L-shaped support members substantially parallel to the intermediate bar member. In some embodiments, the L-shaped member may be shaped in the form of a lower-case 1, the tab members being absent.

Among other things, it is an advantage of the inventive concept to provide a wire spacer that does not suffer from problems or deficiencies associated with prior solutions. Still further, the inventive concept may have preset slots or holes.

The inventive concept, in some embodiments, is designed to be adjustable both in width and depth. The inventive concept may include a semi-circular divot, pocket, or finger that allows the zip-tie to quickly go around the intermediate bar member in the center to allow metal encased bundled wires or other wires or cables to be attached.

The inventive concept now will be described more fully hereinafter with reference to the accompanying drawings, which are intended to be read in conjunction with both this summary, the detailed description, and any preferred and/or particular embodiments specifically discussed or otherwise disclosed. This inventive concept may, however, be embodied in many different forms and should not be construed as limited to the embodiments set forth herein; rather, these embodiments are provided by way of illustration only and so that this disclosure will be thorough, complete, and will fully convey the full scope of the inventive concept to those skilled in the art.

### BRIEF DESCRIPTION OF THE DRAWINGS

FIG. 1 illustrates a bottom view of a cable or wire management spacing and bracing device according to the teachings herein.

FIG. 2 illustrates a front view of the cable or wire bracing or bracket.

FIG. 3 illustrates a top view of the cable or wire bracing or bracket.

FIG. 4 illustrates an extended perspective view of the cable or wire bracing or bracket.

FIG. 5 illustrates a compressed or retracted perspective view of the cable or wire bracing or bracket.

FIG. 6 illustrates a side view of the cable or wire bracing or bracket.

FIG. 7 illustrates a back view of the cable or wire bracing or bracket.

FIG. 8 illustrates the cable or wire bracing or bracket used as a wire management system.

FIG. 9 illustrates a drywall mount of the cable or wire bracing or bracket.

FIG. 10 illustrates an extended bottom view of the cable or wire bracing or bracket.

FIG. 11 illustrates a perspective view of the cable or wire bracing or bracket with thumb tab members.

FIG. 12 illustrates extending and retracting elements and features using thumb tab members of the cable or wire bracing or bracket.

FIG. 13 illustrates top and bottom portions of an intermediate bar member of the cable or wire bracing or bracket.

FIG. 14 illustrates L-shaped support members of the cable or wire bracing or bracket.

FIG. 15 illustrates longitudinal slide support members of the cable or wire bracing or bracket.

FIG. 16 illustrates a substantially symmetrical, substantially cuboid, planarly disposed, detachable, connector platform of the cable or wire bracing or bracket.

FIG. 17 illustrates the substantially symmetrical, substantially cuboid, planarly disposed, detachable, connector platform of the cable or wire bracing or bracket with cables connected.

FIG. 18 illustrates extending and retracting elements or features of the cable or wire bracing or bracket with the connector platform.

FIG. 19 illustrates use of the substantially symmetrical, substantially cuboid, planarly disposed, detachable, connector platform cable or wire bracing or bracket as a wire management system.

FIG. 20 illustrates a perspective view of the cable or wire bracing or bracket with a metal spine member and gang boxes.

FIG. 21 illustrates a front and a perspective view of the cable or wire bracing or bracket with gang boxes.

### DETAILED DESCRIPTION OF THE INVENTION

Following are more detailed descriptions of various related concepts related to, and embodiments of, methods and apparatus according to the present disclosure. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes.

The various embodiments disclosed provide for a wire or cable management bracket 110 of a wire spacing and bracing management device and system 110 The teachings provided herein can also be used for other related installations, such as in plumbing for organizing water and gas lines. The inventive concept is primarily, but not necessarily limited to, an adjustable electrical wire spacer and holder.

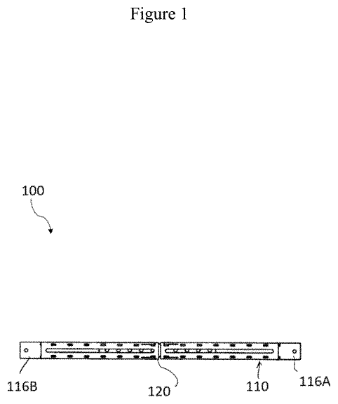

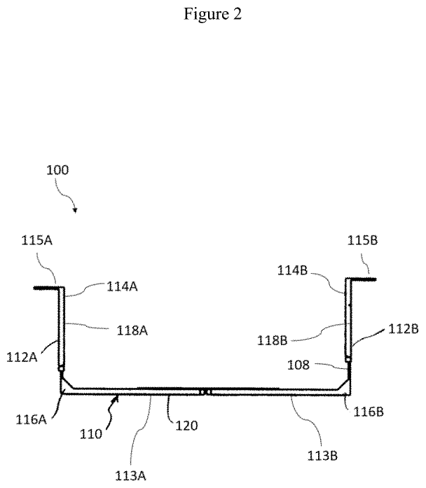

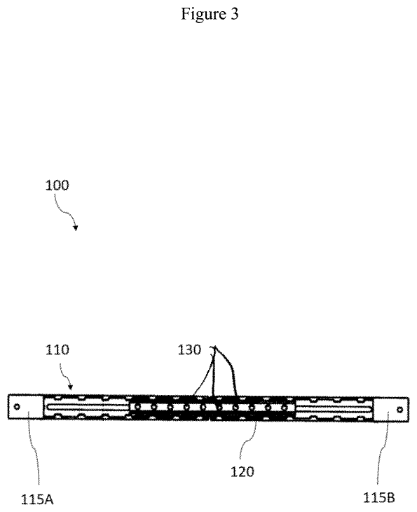

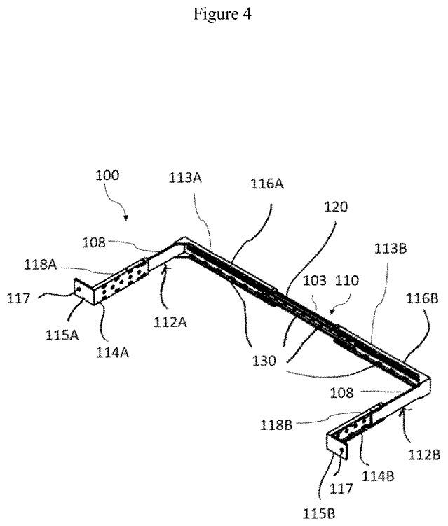

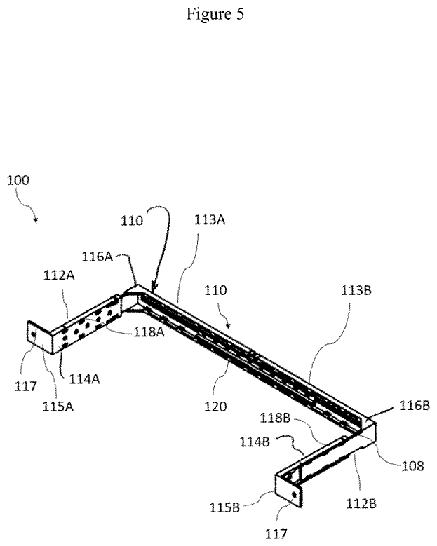

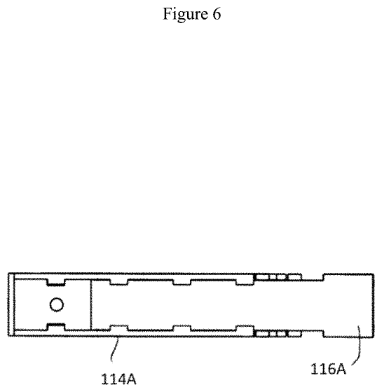

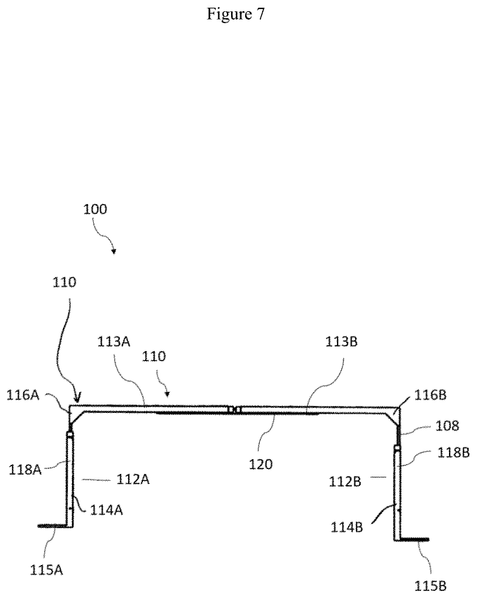

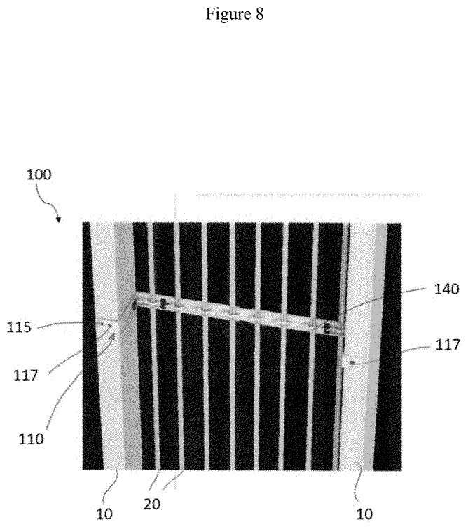

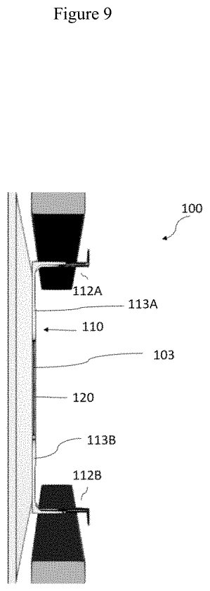

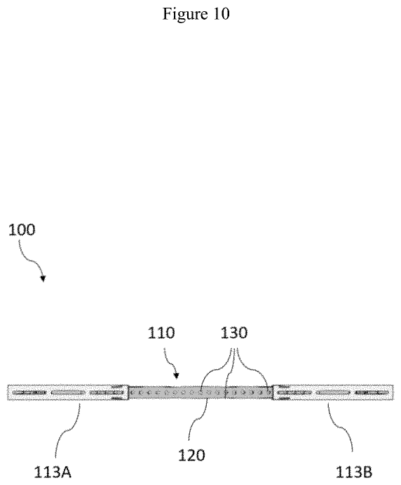

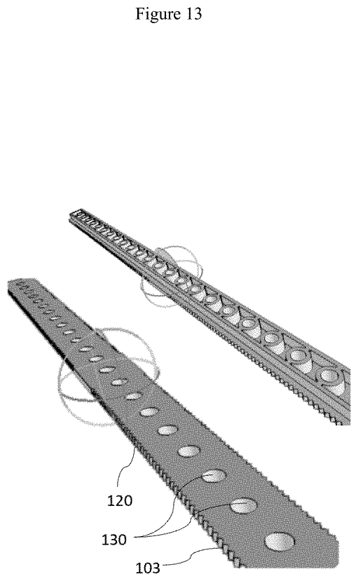

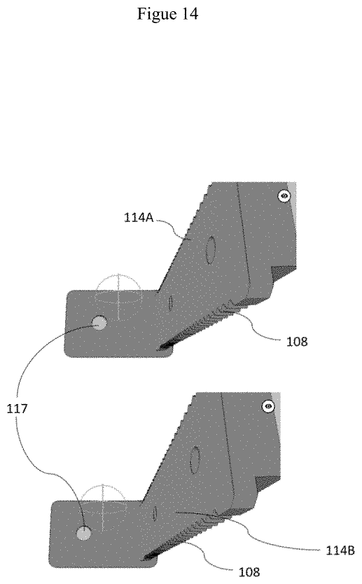

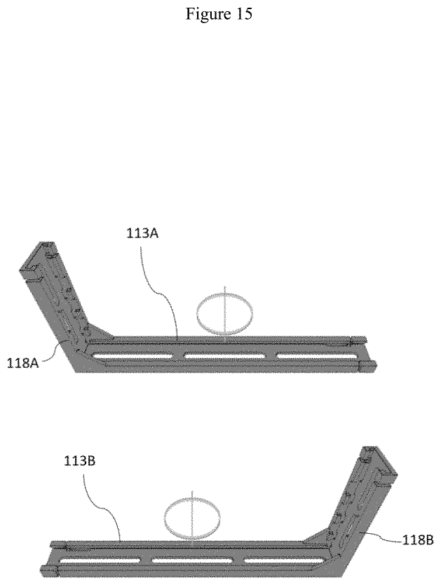

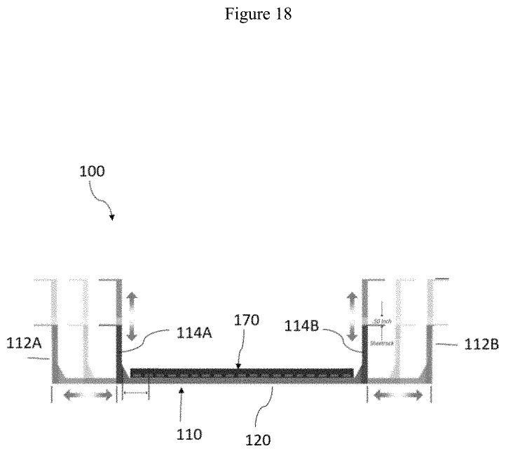

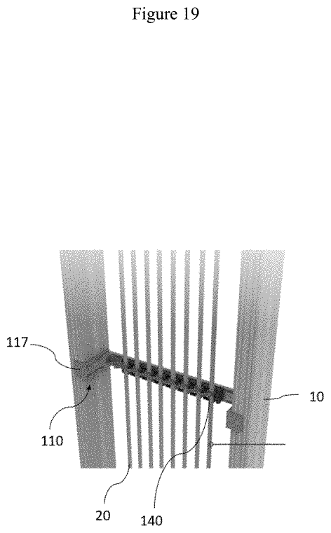

Referring to the figures, FIGS. 1-21 illustrate various views and embodiments of a cable management bracket 110 according to the teachings herein. With specific reference to FIGS. 4 and 8, FIG. 8 illustrates an example embodiment of a cable management system 100 with a wire or cable management bracket 110 designed to secure a plurality of wires or cables 20 between two studs 10. The cable bracket 110 is coupled to studs 10 via a set of L-shaped side support brackets 112A and 112B and includes an intermediate bar member 120 designed to brace and space wires or cables 20 in an electrical installation. In one example embodiment, cable bracket 110 is one continuous configuration having a substantially U-shaped construction as illustrated. In this example embodiment of the cable bracket 110, the bracket includes several members to facilitate configurability depending on the construction environment. For instance, L-shaped side support brackets 112A and 112B include sliding brackets 114A and 114B to configure the inset aspect of bracket member 110 with respect to studs 10 (shown as contracted in FIG. 5). Longitudinal slide support members 113A and 113B are contiguous to and slidably coupled to longitudinal side portions 103 of the intermediate bar member 120 to facilitate sliding movement along a length of the intermediate bar member 120. Lateral slide support members 118A and 118B are contiguous to and slidably coupled to latitudinal side portions 108 of the L-shaped support members 112A and 112B to facilitate sliding movement along a length of the L-shaped support member 112A and 112B disposed substantially perpendicular to the intermediate bar member 120.

Configurability is also shown as cable bracket 110 can expand or contract laterally between the two studs 10 by two L-shaped bracket ends 116A and 116B that engage intermediate bar member 120 in a sliding relationship. In this example embodiment, bracket ends 116A and 116B along with intermediate bar member 120 include a plurality of tie down holes or slots 130 to be used with cable tie downs 140 to secure cables 20 against the intermediate bar member 120 of the cable bracket 110.

In this example embodiment, cable tie downs 140 extend through the tie down slots 130 and wrap around the cables 20 to secure the cables against the bar 120. The tie downs 140 may be plastic strips that are self-securing (such as cable ties), such as zip ties, tie wraps, straps, clips, and the like. Alternatively, the tie downs 140 may be a strap, such as of a cloth material, having a fastener disposed on at least one end, such as a hook and loop fastener. Bracket member 110 optionally includes two tabs or plates protruding from members 115A and 115B for securing bracket member 110 to studs 10 with a screw or nail through holes 117.

In a related example embodiment, some of the cables 20 are secured to L-shaped side brackets 112A and 112B rather than the intermediate bar member 120. Clips or staples can be used to secure these cables. The various brackets described herein are made of metal but can be made of plastic.

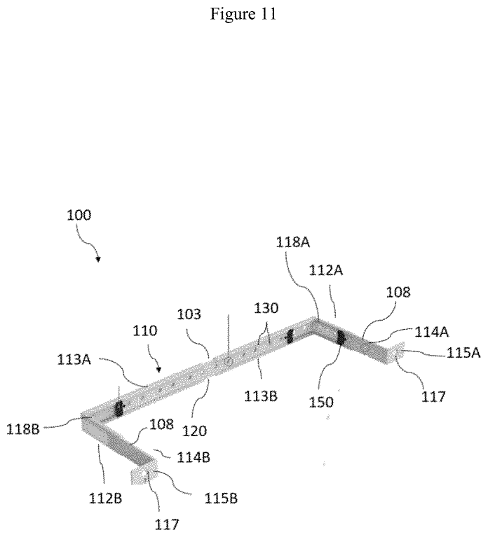

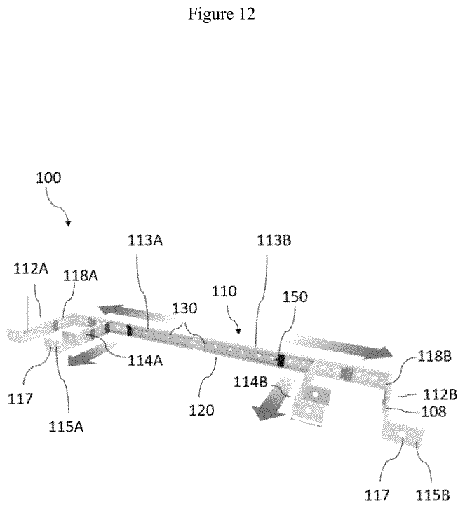

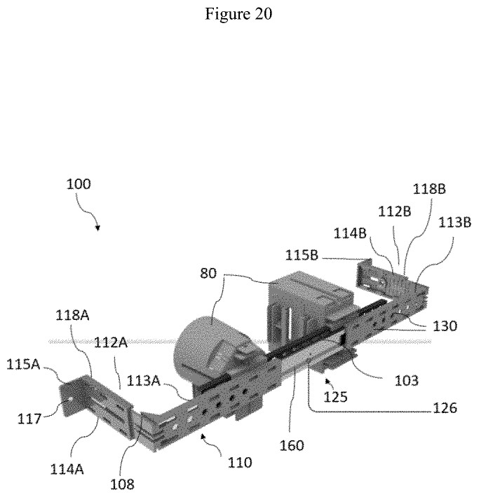

A related embodiment further includes, with specific reference to FIGS. 11 and 12, one or more thumb sliders 150 coupled to the L-shaped brackets and side supports 112A and 112B to facilitate sliding movement along a length of the intermediate bar member 120 and along the L-shaped brackets 112A and 112B. In another related embodiment, with specific reference to FIG. 20, a sheet metal spine member 160 is incorporated as the intermediate bar member 120 extending along the length of the intermediate bar member position 125 substantially equidistant from a center portion 126 of the length of the intermediate bar member position 125. The metal spine member is designed to allow more weight to be supported at the intermediate bar member position 125 than with the intermediate bar member 120 alone that is not also the sheet metal spine member 160.

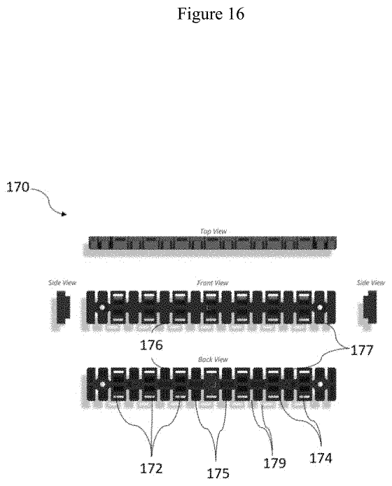

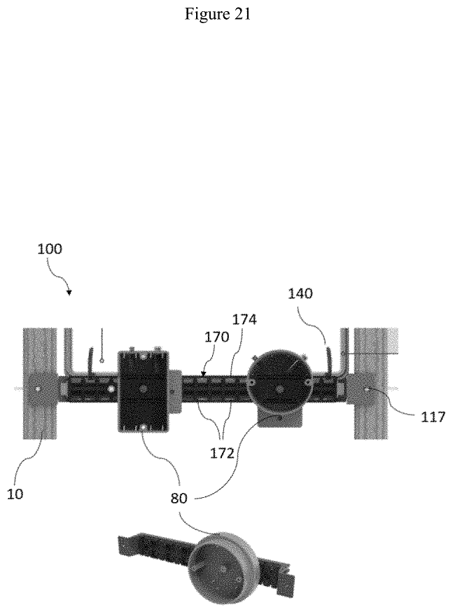

In one further embodiment, with specific reference to FIGS. 16, 17, 18, and 21, a substantially symmetrical, substantially cuboid, planarly disposed, detachable, connector platform or body member 170 is removably coupled lengthwise to the length of the intermediate bar member 120 or assemblies thereon to the intermediate bar member position 125, a plurality of substantially rectangular slot assembly members 172 disposed along the length of the connector platform 170, each slot assembly member including at least one circumscribable side portion 174, the connector platform designed, with specific reference to FIGS. 20 and 21, to be mounted by or thereon (or receive and support) at least one gang box member 80 (or multi-gang box member) or one or more cable or wire members 20, the cable or wire members 20 circumscribed by at least one tie down member 140, the tie down member 140 circumscribing at least one of the at least one circumscribable side portions 174.

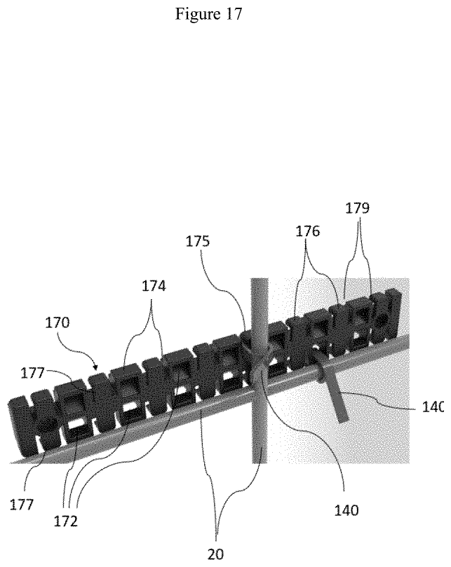

In one further embodiment, with specific reference to FIGS. 16 and 17, at least one L-shaped attachment member 176 is disposed adjacent to and coplanar to at least one rectangular slot assembly member 172 of the connector platform, a foot portion of the L-shaped attachment 175 substantially perpendicular to a stem portion 177 and designed to extend to substantially overlay the thickness of the tie down member 140 circumscribing the stem portion 177.

One of ordinary skill in the art would recognize that the connector platform 170 may be coupled to the intermediate bar member 120, or assemblies thereon, by clip members disposed on the connector platform 170 by attachment members such as a screw or nail member with at least one slot or hole member 130 disposed through the connector platform 170. Hence, connector platform 170 as a standalone device may be coupled directly to a surface or stud 10 without being coupled to the intermediate bar member 120 or may effectively serve as the intermediate bar member 120.

In one embodiment of the connector platform 170, at least one L-shaped attachment member 176 is disposed adjacent to and coplanar to at least one rectangular slot assembly member 172, the foot portion of the L-shaped attachment 175 substantially perpendicular to the stem portion 177 and designed to extend to substantially overlay the thickness of a polymer tie member 140 circumscribing the stem portion 177. The connector platform 170, in this embodiment, is designed to receive wire or cable members 20 running substantially perpendicular to each other.

One embodiment of the connector platform 170 features, with specific reference to FIGS. 16 and 17, a semi-circular divot 179 that can be circumscribed by ties such as zip ties 140.

The intermediate bar member 120, in some embodiments, can adjust in width and depth, adjustable to the required height based on custom layouts, state laws and regulations, and is well-suited to industry standard metal encased wires.

The following patents are incorporated by reference in their entireties: U.S. Pat. Nos. 8,093,499; 7,391,625 and 6,785,459.

While the inventive concept has been described above in terms of specific embodiments, it is to be understood that the inventive concept is not limited to these disclosed embodiments. Upon reading the teachings of this disclosure, many modifications and other embodiments of the inventive concept will come to mind of those skilled in the art to which this inventive concept pertains, and which are intended to be and are covered by both this disclosure and the appended claims. It is indeed intended that the scope of the inventive concept should be determined by proper interpretation and construction of the appended claims and their legal equivalents, as understood by those of skill in the art relying upon the disclosure in this specification and the attached drawings.

1. A cable or wire management bracket system comprising:
an intermediate bar member having a plurality of hole or slot members located along a length of the bar member, the bar member having distal ends;
a first and second L-shaped support member located at each distal end, respectively, each L-shaped support member having a side support member protruding laterally from the intermediate bar member; and
a plurality of tie down members adapted to protrude through a subset of the hole or slot members so as to brace or secure a cable or wire to the intermediate bar member.

2. The cable management bracket system of claim 1 wherein the L-shaped support members include a sliding side support member adapted to extend and contract laterally from the intermediate bar member to increase or decrease a length of the cable management bracket.

3. The cable management bracket system of claim 1 wherein the L-shaped support members include a sliding side support member adapted to extend and contract laterally from the intermediate bar member to increase or decrease a length of the cable management bracket and the L-shaped support members adapted to extend and contract laterally and perpendicularly from the intermediate bar member to increase or decrease a depth of the cable management bracket.

4. The cable management bracket system of claim 3 further including one or more thumb sliders coupled to the L-shaped brackets and side supports to facilitate sliding movement along a length of the intermediate bar member and along the L-shaped brackets.

5. A cable or wire management bracket system comprising:
an intermediate bar member having one or more holes or slots located along a length of the bar member, the bar member having distal ends;
longitudinal slide support members contiguous to and slidably coupled to longitudinal side portions of the intermediate bar member to facilitate sliding movement along a length of the intermediate bar member;
a first and second L-shaped support member located at each distal end, respectively, each L-shaped support member having a side support member protruding substantially laterally from the intermediate bar member;
lateral slide support members contiguous to and slidably coupled to latitudinal side portions of the L-shaped support member to facilitate sliding movement along a length of the L-shaped support member disposed substantially perpendicular to the intermediate bar member length; and
one or more tie down members adapted to brace or secure a cable or wire substantially to the intermediate bar member.

6. The cable management bracket system of claim 5 further including one or more thumb sliders coupled to the L-shaped brackets and side supports to facilitate sliding movement along a length of the intermediate bar member and along the L-shaped brackets.

7. The cable management bracket system of claim 5 wherein a sheet metal spine member is incorporated as the intermediate bar member extending along the length of an intermediate bar member position substantially equidistant from a center portion of a length of the intermediate bar member position.

8. The cable management bracket system of claim 5 wherein a substantially symmetrical, substantially cuboid, planarly disposed, detachable, connector platform is removably coupled lengthwise to the length of the intermediate bar member or assemblies thereon, a plurality of substantially rectangular slot assembly members disposed along the length of the connector platform, each slot assembly member including at least one circumscribable side portion, the connector platform adapted to be mounted by at least one gang box member or one or more cable or wire members, the cable or wire members circumscribed by at least one tie down member secured to the connector platform.

9. The cable management bracket system of claim 8 wherein at least one L-shaped attachment stud is disposed adjacent to and coplanar to at least one rectangular slot assembly member of the connector platform, the foot portion of the L-shaped attachment substantially perpendicular to the stem portion and adapted to extend to substantially overlay the thickness of the tie down member circumscribing the stem portion.

10. A cable or wire management bracket method comprising:
attaching to a surface an intermediate bar member having one or more hole or slot members located along a length of the bar member, the bar member having distal ends;
longitudinally sliding slide support members contiguous to and slidably coupled to longitudinal side portions of the intermediate bar member facilitating sliding movement along a length of the intermediate bar member to set the length of the intermediate bar member;
attaching to a surface a first and second L-shaped support member located at each distal end, respectively, each L-shaped support member having a side support member protruding substantially laterally from the intermediate bar member;
laterally sliding lateral support members contiguous to and slidably coupled to latitudinal side portions of the L-shaped support member facilitating sliding movement along a length of the L-shaped support member disposed substantially perpendicular to the intermediate bar member length to set the length of the L-shaped support members and corresponding depth of the cable and wire management bracket; and
using one or more tie down members to brace or secure a cable or wire substantially to the intermediate bar member.

11. The cable management bracket method of claim 10 further including one or more thumb sliders coupled to the L-shaped brackets and side supports to facilitate sliding movement along a length of the intermediate bar member and along the L-shaped brackets.

12. The cable management bracket method of claim 10 wherein a sheet metal spine member is incorporated as the intermediate bar member extending along the length of an intermediate bar member position substantially equidistant from a center portion of the length of the intermediate bar member position.

13. The cable management bracket method of claim 10 wherein a substantially symmetrical, substantially cuboid, planarly disposed, detachable, connector platform is removably coupled lengthwise to the length of the intermediate bar member or assemblies thereon, a plurality of substantially rectangular slot assembly members disposed along the length of the connector platform, each slot assembly member including at least one circumscribable side portion, the connector platform mounted by one or more of a wire, cable, or gang box member, the wire or cable members circumscribed by at least one tie down member secured to the connector platform.

14. The cable management bracket of claim 13 wherein at least one L-shaped attachment stud is disposed adjacent to and coplanar to at least one rectangular slot assembly member of the connector platform, the foot portion of the L-shaped attachment substantially perpendicular to the stem portion, a polymer tie member coupling each of at least one wire or cable member contiguously abutting the stem portion of the at least one L-shaped attachment member, the foot portion of the at least one L-shaped attachment member substantially overlaying the thickness of the tie down member circumscribing the stem portion.
